(19) United States
(12) Patent Application Publication
(10) Pub. No.: US 2014/0175338 A1
(43) Pub. Date: Jun. 26, 2014

(54) ELECTRICALLY CONDUCTIVE POLYPHENYLENE SULFIDE COMPOUNDS

(71) Applicant: POLYONE CORPORATION, Avon Lake, OH (US)

(72) Inventors: Joseph C GOLBA, Avon Lake, OH (US); Jane M SPIKOWSKI, Westlake, OH (US); Brad J DAVISON, Youngstown, OH (US); Kebin GENG, Solon, OH (US)

(73) Assignee: POLYONE CORPORATION, Avon Lake, OH (US)

(21) Appl. No.: 13/797,305

(22) Filed: Mar. 12, 2013

Related U.S. Application Data
(60) Provisional application No. 61/740,660, filed on Dec. 21, 2012.

(51) Int. Cl. H01B 1/12

(52) U.S. Cl. CPC H01B 1/12
USPC 252/507; 252/511

(57) ABSTRACT

An electrically conductive polymer compound is disclosed. The compound comprises a matrix comprising polyphenylene sulfide and carbon nanotubes and glass fibers dispersed in the matrix. The carbon nanotubes are disaggregated and disagglomerated within the polyphenylene sulfide, when the compound is viewed at 20,000× magnification. The compound is useful for making extruded or molded plastic articles that need electrical properties.

### CLAIM OF PRIORITY

This application claims priority from U.S. Provisional patent application Ser. No. 61/740,660 bearing Attorney Docket Number 12012025 and filed on Dec. 21 2012, which is incorporated by reference.

### FIELD OF THE INVENTION

This invention concerns polyphenylene sulfide compounds which have electrical properties.

### BACKGROUND OF THE INVENTION

Thermoplastic articles can be superior to metal because they do not corrode and can be molded or extruded into any practical shape. Thermoplastic articles are also superior to glass because they do not shatter when cracking.

Thermoplastic articles can be made to be electrically conductive if sufficient amounts of electrically conductive particles are dispersed in the articles. Many types of articles need to be electrically conductive, and neither metal nor glass articles is practical.

### SUMMARY OF THE INVENTION

Therefore, what the art needs is an electrically conductive thermoplastic compound that can be used to make thermoplastic articles for use in electrically conductive circumstances, particularly where the surface of the thermoplastic article needs to have at least low surface electrical resistivity or even electrical conductivity.

The art also needs an electrically conductive thermoplastic compound that is durable and has a high melting point, so that the thermoplastic article can function in temperatures above ambient temperature and in circumstances where the article encounters friction against other materials.

The present invention has solved that problem by relying on polyphenylene sulfide polymer to provide the high temperature and durability, with electrically conductive particles dispersed therein. Moreover, the present invention has found that carbon nanotubes should be the only type of electrically conductive particle dispersed in the polyphenylene sulfide in order to minimize the effect on mechanical properties on polyphenylene sulfide than if other conductive fillers, such as carbon black and metallic fillers, were used.

Thus, one aspect of the invention is an electrically conductive thermoplastic compound, comprising (a) polyphenylene sulfide; (b) glass fibers; and (c) carbon nanotubes dispersed in an amount ranging from about 0.1 to about 10 weight percent of the compound in the polyphenylene sulfide, without aggregation or agglomeration of nanotubes in the polyphenylene sulfide when the compound is viewed at 20,000× magnification.

Features of the invention will be explained below in relation to the following drawings.

### BRIEF DESCRIPTION OF THE DRAWING

FIG. 1 is a collection of carbon nanotubes as delivered from the vendor viewed at 50× magnification.

FIG. 2 is a collection of carbon nanotubes as delivered from the vendor viewed at 100× magnification.

FIG. 3 is a collection of carbon nanotubes as delivered from the vendor viewed at 500× magnification.

FIG. 4 is a collection of carbon nanotubes as delivered from the vendor viewed at 1000× magnification.

FIG. 5 is a collection of carbon nanotubes as delivered from the vendor viewed at 5,000× magnification.

FIG. 6 is a collection of carbon nanotubes as delivered from the vendor viewed at 10,000× magnification.

FIG. 7 is a collection of carbon nanotubes as delivered from the vendor viewed at 15,000× magnification.

FIG. 8 is a collection of carbon nanotubes as delivered from the vendor viewed at 25,000× magnification.

FIG. 9 is a collection of carbon nanotubes as delivered from the vendor viewed at 50,000× magnification.

FIG. 10 is a collection of carbon nanotubes as delivered from the vendor viewed at 100,000× magnification.

FIG. 11 is a microtome section of the compound of the invention viewed at 100× magnification.

FIG. 12 is a microtome section of the compound of the invention viewed at 300× magnification.

FIG. 13 is a microtome section of the compound of the invention viewed at 500× magnification.

FIG. 14 is a microtome section of the compound of the invention viewed at 5,000× magnification.

FIG. 15 is a microtome section of the compound of the invention viewed at 20,000× magnification.

FIG. 16 is a microtome section of the compound of the invention viewed at 50,000× magnification.

FIG. 17 is a micotome section of the compound of the invention viewed at 100,000× magnification.

### EMBODIMENTS OF THE INVENTION

Polyphenylene Sulfides

Polyphenylene sulfides are polymers containing a phenyl moiety and one or more sulfides bonded thereto. Those skilled in the art will recognize the variety of commercially available polyphenylene sulfides are suitable for use in the present invention. Polyphenylene sulfides have a glass transition temperature of about 90° C. measured at 10° C./min (ISO 11357); a melt temperature of about 280° C. measured at 10° C./min (ISO 11357); a tensile modulus of 3800 MPa measured at 1 mm/min (ISO 527-2/1A); a flexural modulus of 3750 MPa measured at 23° C. (ISO 178); a Notched Izod impact strength of 3.5 kJ/m² measured at 23° C. (ISO 180/1A); and other properties indicative of good melt strength and melt flow and use in extrusion and injection molding .

Non-limiting examples of such commercially available polyphenylene sulfides (“PPS”) include Ryton brand PPS powders in various grades from Chevron Phillips Chemical Co. of The Woodlands, Tex., Haton brand PPS from China Lumena New Materials Co. of Chengdu, China, and Fortron brand PPS powders, pellets, or crystallized pellets from Ticona/Celanese of Florence, Kentucky. Any of the patents in the literature known to those skilled in the art are appropriate for determining a suitable choice, without undue experimentation.

Optional Second Polymer

Optionally, any polymer which is compatible and preferably miscible with PPS can be used in a blend with PPS to achieve particular processing or performance properties when making thermoplastic articles. Without undue experimentation, one skilled in the art can determine which polymers are suitable for blending with PPS and select from them. Non-limiting examples of such polymers include liquid crystal polymer (LCP), syndiotactic polystyrene (s-PS), polyimide, polyarylsufone, polyphenylene oxide (polyphenylene ether), polyarylcarbonates, polyamide, fluoropolymer, and combinations thereof.

Glass Fibers

In prior experiments, it was found that a compound of PPS and carbon nanotubes was unacceptable brittle. The addition of glass fibers to the compound reduced the brittleness of the compound and greatly improved the non-electrical performance properties of the compound without adversely affecting the electrical performance properties of the compound.

Glass fibers are a well known and useful filler because they can provide reinforcement to a polymer compound.

Non-limiting examples of glass fibers are chopped strands, long glass fiber, and the like.

Glass fiber is commercially available from a number of sources, but ThermoFlow brand glass fibers from Johns Manville are particularly preferred, including ThermoFlow chopped glass fiber strand grade 768 for use with PPS. Grade 768 has a silane based sizing to assist in dispersion of the glass fibers in such high temperature thermoplastic resins as PPS. Grade 768 is made from E glass and has a typical diameter of 10 micrometers and a typical length of 4 millimeters.

Carbon Nanotubes

The carbon nanotubes are used in this present invention, expressly to the exclusion of other types carbonaceous conductive particles. The reason for the selection of carbon nanotubes is based on the tremendous electrically conductivity that can be achieved with them, as compared to other types of electrically conductive particles, whether metallic or non-metallic or both. Relatively small amounts of carbon nanotubes, with their considerably large aspect ratios, provide a surface resistivity of less than 10¹² ohms/square in compounds of the present invention. It is viewed that any other type of electrically conductive particle would interfere with the use of carbon nanotubes as the sole means of providing electrical conductivity.

Carbon nanotubes have aspect ratios ranging from 10:1 to 10,000:1 and are surprisingly excellent for dispersion within PPS and glass fibers.

Carbon nanotubes are categorized by the number of walls. The present invention can use both single-wall nanotubes (SWNT) or multi-wall nanotubes (MWNT) or both.

To achieve such aspect ratios, nanotubes can have a length ranging from about 1 μm to about 10 μm, and preferably from about 1 μm to about 5 μm and a width or diameter ranging from about 0.5 nm to about 1000 nm, and preferably from about 0.6 nm to about 100 nm.

Also, such conductive media should have resistivities ranging from about 1×10⁻⁸ Ohm·cm to about 3×10² Ohm·cm, and preferably from about 1×10⁻⁶ Ohm·cm to about 5×10⁻¹ Ohm·cm.

More information about MWNT can be found at U.S. Pat No. 4,663,230 (Tennent). More information about SWNT can be found in U.S. Pat. No. 6,692,717 (Smalley et al.)

Non-limiting examples of suppliers of carbon nanotubes, either SWNT, MWNT, or both are Carbon Nanotechnologies of Houston, Texas; Hyperion Catalysis International of Cambridge, Mass.; BayerMaterial Science; Arkema; Catalytic Materials of Pittsboro, N.C.; Apex Nanomaterials of San Diego, Calif.; Cnano Technologies of Menlo Park, Calif.; Nanolntegries of Menlo Park, Calif.; Hanwha Nanotech of Incheon, Korea; Nanocyl of Belgium; Raymor Industries of Boisbriand, Quebec, Canada; and dozens more.

Particularly preferred is FloTub™ 9000 H MWNT from Cnano Technologies.

The carbon nanotubes can be added at the time of melt compounding of the PPS, fed downstream of the throat after suitable melting of the PPS has occurred, or can be made into a masterbatch to facilitate a two-step process of dispersion into the ultimate thermoplastic compound.

Though it has been viewed as preferable for the masterbatch route to be used, because carbon nanotubes are extraordinarily small particles need special equipment to be dispersed into a matrix, unexpectedly and quite surprisingly, the use of PPS as the melt polymer and glass fibers generates such levels of dispersion that no aggregates or agglomerates of the carbon nanotubes can be found in Scanning Electron Microscopy (SEM) of up to 20,000× magnification and even 50,000× or 100,000× magnifications.

Optional Other Additives

While carbon nanotubes serve as the only electrically conductive particles, the compound of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; catalyst deactivators, and combinations of them.

Ingredients

Table 1 shows the acceptable, desirable, and preferred amounts of each of the ingredients discussed above, recognizing that the optional ingredients need not be present at all. All amounts are expressed in weight percent of the total compound.

TABLE 1
Range of Ingredients

| | Acceptable | Desirable | Preferable |
|---|---|---|---|
| Polyphenylene Sulfide | 5-94 | 30-89 | 51-84 |
| Polymer | | | |
| Optional Second Polymer | 0-30 | 0-30 | 0-20 |
| Glass Fibers | 5-65 | 10-40 | 15-35 |
| Carbon Nanotubes | 0.1-10 | 0.5-5 | 1-2 |
| Optional Other Additives | 0-10 | 0-5 | 0-2 |

Processing

The preparation of compounds of the present invention is uncomplicated. The compound of the present can be made in batch or continuous operations. As mentioned above, it is possible to have the carbon nanotubes be initially dispersed into a concentrated masterbatch by experts who work with carbon nanotubes regularly and have the equipment and expertise to provide an excellent dispersion.

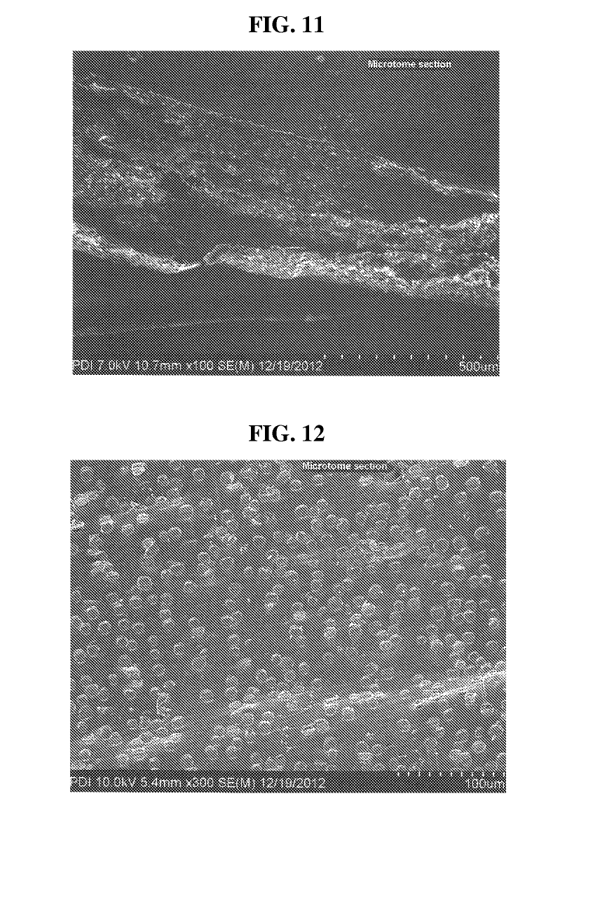

But, significantly, this invention has shown that raw, fluffy tangles of nanotubes delivered into and well mixed within a melt-mixing vessel can result in total disaggregation and total disagglomeration when the compound is viewed at 20,000×; 50,000×; and even 100,000× magnification. The Examples below shows that result in conjunction with FIGS. 11-17.

Mixing in a continuous process typically occurs in a single or twin screw extruder that is elevated to a temperature that is sufficient to melt the PPS polymer matrix with addition of other ingredients either at the head of the extruder or downstream in the extruder. Extruder speeds can range from about 600 to about 1000 revolutions per minute (rpm), and preferably from about 600 to about 1200 rpm. Typically, the output from the extruder is pelletized for later extrusion or molding into polymeric articles.

Mixing in a batch process typically occurs in a Banbury mixer that is capable of operating at a temperature that is sufficient to melt the polymer matrix to permit addition of the solid ingredient additives. The mixing speeds range from 600 to 1000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.elsevier.com), one can make articles of any conceivable shape and appearance using compounds of the present invention.

### USEFULNESS OF THE INVENTION

Compounds of the present invention can be molded into any shape which benefits from having electrically conductive or static dissipative surfaces, high stiffness in thin wall sections, and a low coefficient of thermal expansion. Compounds of the present invention can be used by anyone who purchases Stat-Tech brand conductive polymer compounds from PolyOne Corporation (www.polyone.com) for a variety of industries, such as the medical device industry or the electronics industry where disposable or recyclable plastic articles are particularly useful in laboratory or manufacturing conditions.

Examples of electronics industry usage includes media carriers, process combs, shipping trays, printed circuit board racks, photomask shippers, carrier tapes, hard disk drive components, sockets, bobbins, switches, connectors, chip carriers and sensors. etc. PPS compounds can withstand high temperatures, making them even more useful than less high performance polymers such as polyolefins or polyamides.

Examples of medical industry usage includes electromagnetic interference shielding articles, tubing, drug inhalation devices, laboratory pipette tips, implantable medical device components, biomedical electrodes, and other devices that need protection from electrostatic discharge, static accumulation, and electromagnetic interference. PPS compounds can replace stainless steel in medical applications and certain grades of commercial PPS are compliant with USP Class VI guidelines and ISO 10993-1. Compounds of the present invention can be both electrically conductive and resistant to medical sterilization methods.

As an example of the usefulness of the invention, three runs of the same formulation having the ingredients shown in Table 2 were made according to the procedure and conditions of Table 3 and Table 4. Table 5 shows the physical and electrical properties, proving the utility of the invention.

TABLE 2
Conductive Polymer Formulation

| Ingredients (Wt. %) | Ex. 1 | Ex. 2 | Ex. 3 |
|---|---|---|---|
| Ticona Fortron ™ 0214 | 68.95 | 68.95 | 68.95 |
| Polyphenylene Sulfide | | | |
| Johns Manville | 29.55 | 29.55 | 29.55 |
| ThermoFlow ™ Chopped | | | |
| Glass Fiber Strands | | | |
| Cnano FloTub ™ 9000 H | 1.50 | 1.50 | 1.50 |
| MWNT | | | |

TABLE 3
Extruder Conditions

| Extruder Type | 27 mm Leistritz Twin Screw |
|---|---|
| | Extruder (60:1 L/D) |
| Order of Addition | PPS added at throat through |
| | water cooled feeder at a rate |
| | of 19.05 kg/hr. |
| | Glass fiber added at 1^{st} side |
| | feeder at Zone 5 at 8.16 kg/hr. |
| | Carbon nanotubes added at 2^{nd} |
| | side feeder at Zone 5 at 0.41 kg/hr. |
| | Output rate: 27.62 kilograms/hour |
| | (60.89 pounds/hour) |
| | Setting |
| Zone 1 (° C.) | 285 |
| Zone 2 (° C.) | 295 |
| Zone 3 (° C.) | 305 |
| Zone 4 (° C.) | 315 |
| Zone 5 (° C.) | 315 |
| Zone 6 (° C.) | 315 |
| Zone 7 (° C.) | 310 |
| Zone 8 (° C.) | 310 |
| Zone 9 (° C.) | 310 |
| Zone 10 (° C.) | 310 |
| Zone 11 (° C.) | 310 |
| Zone 12 (° C.) | 310 |
| Zone 13 (° C.) | 310 |
| Zone 14 (° C.) | 310 |
| Die Zone 15 (° C.) | 310 |
| RPM | 900 |

TABLE 4
Molding Conditions
88 Nissei molding machine
Plaques of 10.2 cm × 10.2 cm × 0.158 cm
Plaques of 10.2 cm × 10.2 cm × 0.317 cm

| Drying Conditions: | |
|---|---|
| Temperature (° C.) | 90 |
| Time (hr) | 14 |
| Temperatures: | |
| Nozzle (° C.) | 327 |
| Zone 2 (° C.) | 332 |
| Zone 3 (° C.) | 327 |
| Mold (° C.) | 138 |
| Oil Temp (° C.) | 32 |
| Speeds: | |
| Screw RPM | 50%-100 |
| % Shot - Inj Vel Stg 1 | 30-30% |
| % Shot - Inj Vel Stg 2 | 26-30% |
| % Shot - Inj Vel Stg 3 | 22-30% |
| % Shot - Inj Vel Stg 4 | 18-30% |
| % Shot - Inj Vel Stg 5 | 14-30% |
| Pressures: | |
| Inj Press Stg - Time (sec) | N/A |
| Injection Pressure 1 | 90% |
| Hold Pressure 2 | 20% |
| Hold Pressure 3 | N/A |
| Back Pressure | 1% |
| Timers: | |
| Injection Hold (sec) | 4 |
| Cooling Time (sec) | 15 |
| Operation Settings: | |
| Shot Size (SM) | 30 |
| Cushion | 9 |
| Cut-Off Position | 10 |
| Cut-Off Pressure | 2000 |
| Cut-Off Time | N/A |
| Cut-Off Mode | POS |
| Decompression | 4 |

TABLE 5
Conductive Polymer Properties

| | | |
|---|---|---|
| Ex. 1 | Ex. 2 | Ex. 3 |

Properties of Plaques of 10.2 cm × 10.2 cm × 0.158 cm

| | | | |
|---|---|---|---|
| Surface Resistivity | 1.8 × 10¹⁰ | 1.9 × 10¹⁰ | 2.7 × 10¹¹ |
| (ASTM D257) | | | |
| Ohm/sq. | | | |
| Volume Resistivity | 2.1 × 10⁹ | 1.4 × 10¹⁰ | 4.9 × 10¹² |
| (ASTM D257) Ohm | | | |

Properties of Plaques of 10.2 cm × 10.2 cm × 0.317 cm

| | | | |
|---|---|---|---|
| Impact, Izod, | 0.788 | 0.791 | 0.776 |
| Notched, ⅛ inch | | | |
| (ASTM D256) ft-lb/in | | | |
| Tensile at Break, | 18,850 | 18,190 | 18,490 |
| 0.2 in/min. | | | |
| (ASTM D638) psi | | | |
| Elongation at break, | 1.6 | 1.6 | 1.7 |
| 0.2 in/min | | | |
| (ASTM 638) % | | | |
| Tensile Modulus, | 1,565,072 | 1,500,137 | 1,493,998 |
| 0.2 in/min | | | |
| (ASTM D638) psi | | | |
| Flexural Modulus | 1400000 | 1411000 | 1421000 |
| ⅛, 0.05 in/min | | | |
| (ASTM D790) psi | | | |
| Surface Resistivity | 7.9 × 10⁶ | 4.2 × 10⁷ | 6.5 × 10⁶ |
| (ASTM D257) | | | |
| Ohm/sq. | | | |
| Volume Resistivity | 2.2 × 10⁷ | 6.2 × 10⁷ | 4.2 × 10⁷ |
| (ASTM D257) Ohm | | | |

Most surprisingly, and contrary to reports in the patent literature, the carbon nanotubes were not aggregated or agglomerated when viewed dispersed in the PPS using magnifications of 20,000×; 50,000×; or even 100,000×.

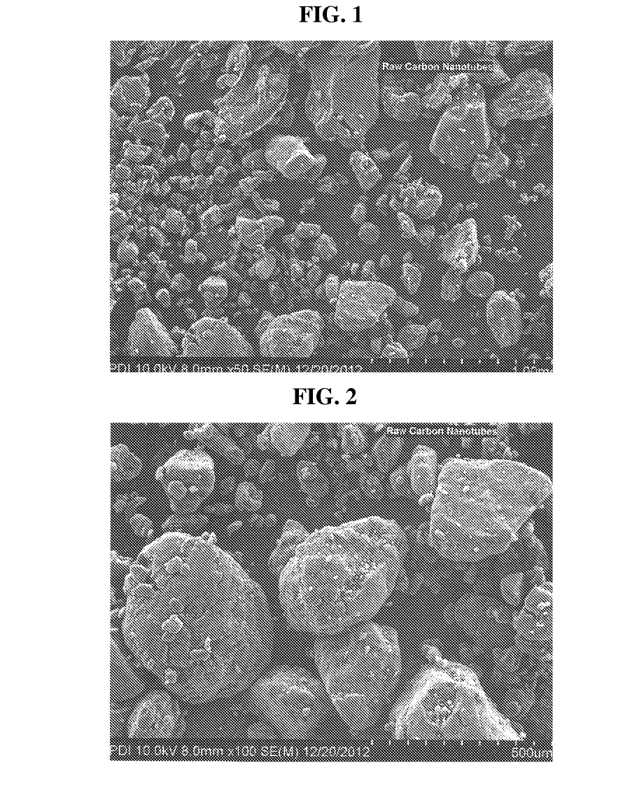

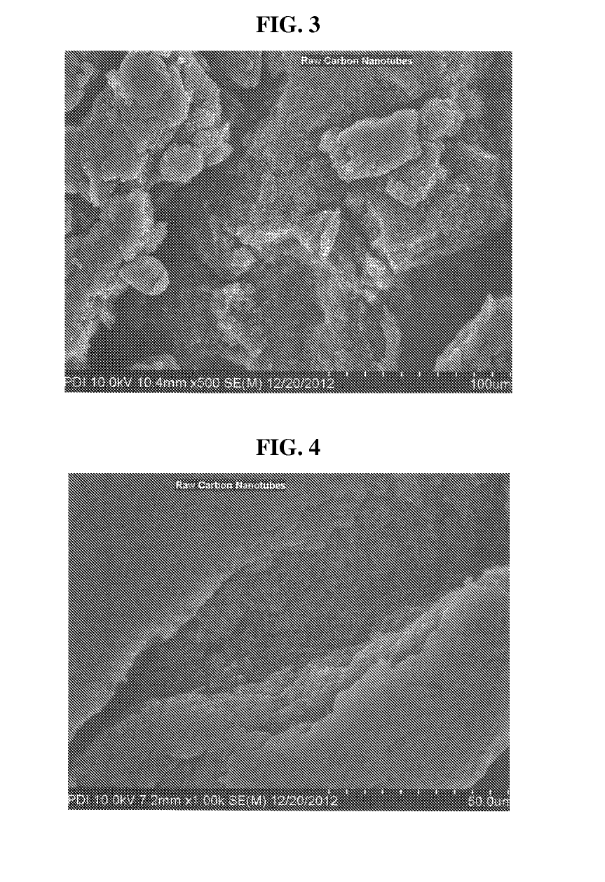

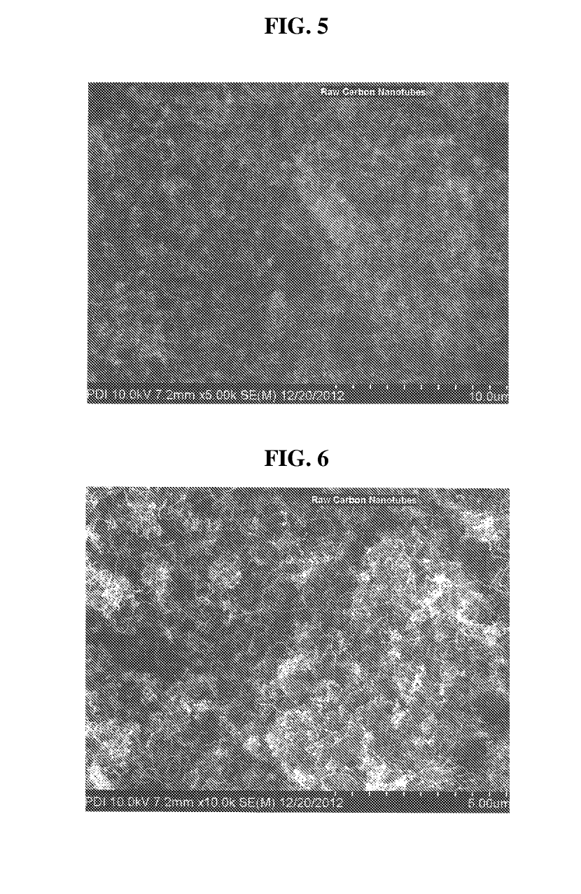

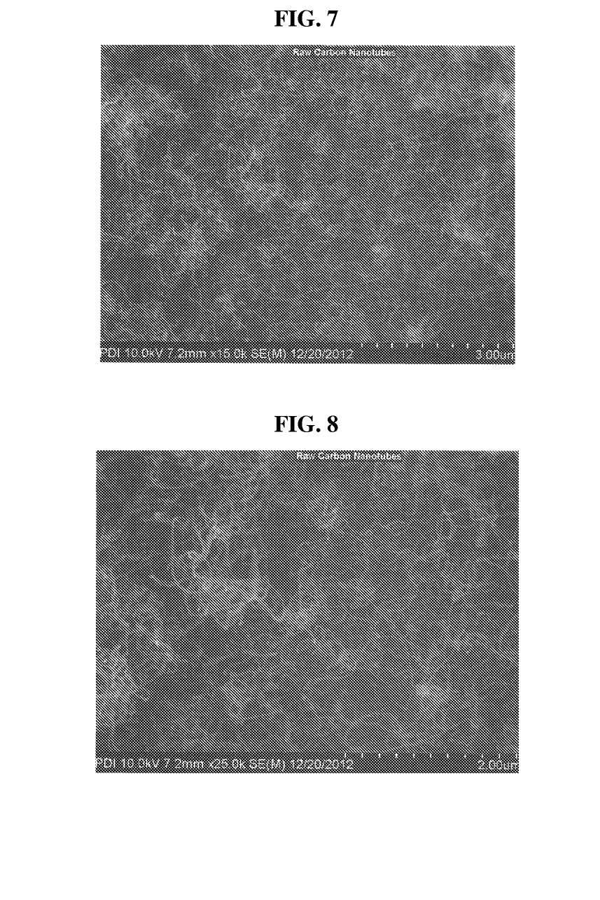

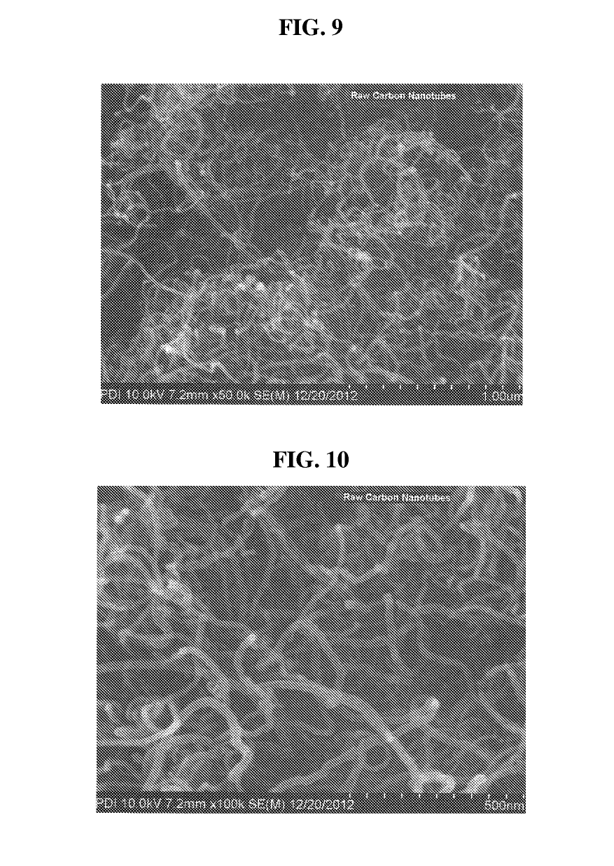

FIGS. 1-10 show Scanning Electron Microscope (SEM) views of the raw Cnano FloTub™ 9000 H multi-wall carbon nanotubes as delivered by Cnano Technologies, progressing from 50× magnification (FIG. 1) through to 100,000× magnification (FIG. 10). As the magnification increases, the delivered agglomerates seen particularly in FIGS. 1-3 demonstrate the massive agglomeration of the nanotubes which are quite known for having considerable affinity each other. As FIG. 4 demonstrates (at 1,000× magnification), within each agglomerate, one can begin to see fibrillar entanglements. At 5,000× magnification (FIG. 5), within each agglomerate, one can begin to see what on a larger scale would be considered to be a non-woven web. At 10,000× magnification (FIG. 6), further visual refinement identifies an incredible mass of entangled strands. At 15,000× magnification (FIG. 7), individual nanotubes twisted and convoluted are within a non-woven nest. At 25,000× magnification (FIG. 8), there is even more identifiable individual nanotubes of twisted and jumbled orientation. At 50,000× magnification (FIG. 9), the longitudinal curvature of individual nanotubes can be seen with as much entanglement and intertwining as seen in the prior Figs. Finally, at 100,000× magnification, (FIG. 10), each individual nanotube takes on identity with thicker and thinner cross-sections along their respective lengths.

Out of the chaos as seen in FIGS. 1-10, the compound of the present invention achieves disaggregation and disagglomeration of the carbon nanotubes.

FIG. 11 is a microtomed section of a plaque of one of the Examples 1-3 (all being of the same formulation). Debris of the microtoming can be seen, but at 100× magnification, nothing else is in view.

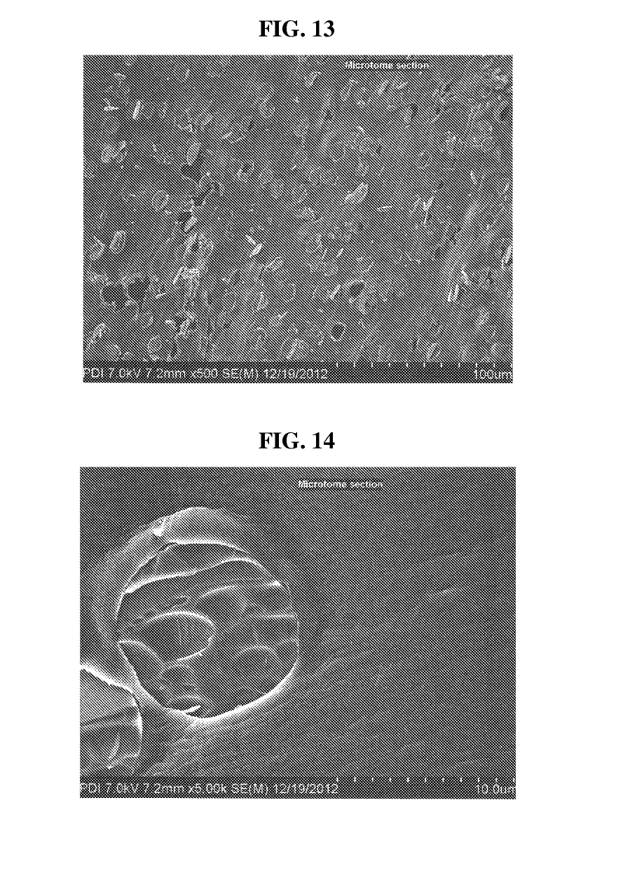

FIG. 12 shows the cut ends of the glass fibers, when seen at 300× magnification. FIG. 13 at 500× magnification shows the glass fiber debris and some holes from which fibers have left. FIG. 14 at 5,000 magnification shows the cut end of a single glass fiber (one of the many seen in FIG. 12) with some very light spots in the remaining field, the beginning of seeing the nanotubes dispersed in the PPS resin. At the point of magnification of FIGS. 12-14, according to the prior art, one should have begun to see agglomerates or aggregates in ranges of 35-250 micrometer. None is seen in FIGS. 12-14.

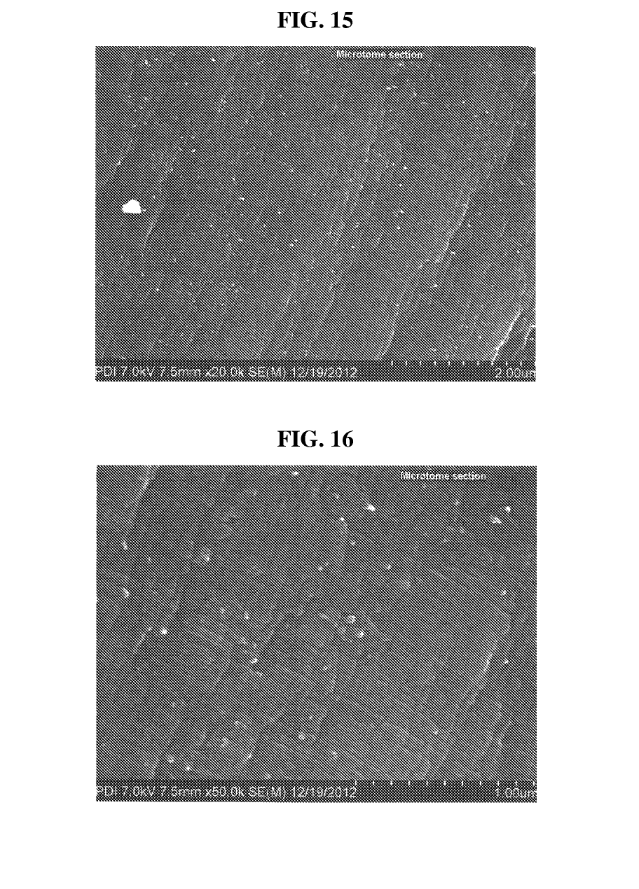

FIG. 15 shows an entire field of PPS resin, at 20,000× magnification, with no glass fiber in view. But there are individual lighter dots well dispersed, not clumped, tangled, aggregated, or agglomerated with each other.

It is truly unexpected that the mass of entangled strands seen at various magnifications in FIGS. 1-10 could be introduced at Zone 5 of a 60:1 L/D twin screw extruder into a molten mass of PPS resin, at the same time as introduction of the glass fibers, and result in such complete dispersion.

At the present time, it is not known exactly the reason for such excellent dispersion, contradicting the teachings of the prior art. Without being limited to a particular theory, the interfacial interactions among the PPS resin (on the millimetric scale), the glass fibers (on the micrometric scale), and the carbon nanotubes (on the nanometric scale) truly have affinity for each other more than the carbon nanotubes or the glass fibers have for each other.

The tangled mess of carbon nanotubes introduced into the side feeder of the extruder is totally untangled upon exit from the extruder.

FIG. 16 at 50,000× magnification proves the point even more. The individual nanotubes are isolated from one another, the nanotube equivalent of exfoliation of nanoclays.

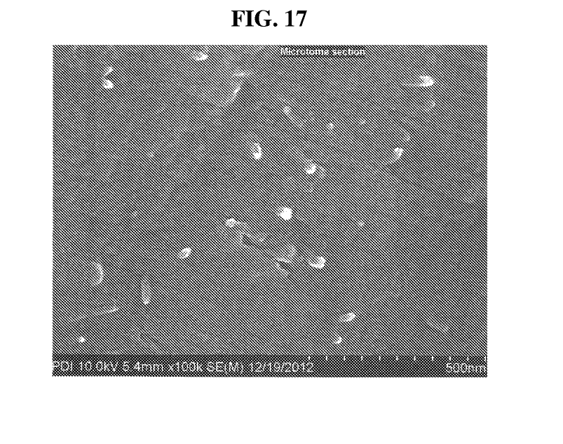

FIG. 17 at 100,000× magnification completes the proof of disaggregation and disagglomeration, especially when compared with the same magnification of the raw carbon nanotubes seen in FIG. 10.

With such demonstration of disaggregation and disagglomeration and the other disclosures above, a person having ordinary skill in the art, without undue experimentation, could tailor the amounts of glass fiber and carbon nanotubes within the PPS resin to achieve a variety of physical properties and a variety of resistivities for a myriad of polymer products benefiting from the maximum value of carbon nanotubes because of their dispersion as shown.

The invention is not limited to the above embodiments. The claims follow.

What is claimed is:

1. An electrically conductive thermoplastic compound, comprising
(a) polyphenylene sulfide;
(b) glass fibers; and
(c) carbon nanotubes dispersed in an amount ranging from about 0.1 to about 10 weight percent of the compound in the polyphenylene sulfide, without aggregation or agglomeration of nanotubes in the polyphenylene sulfide when the compound is viewed at 20,000× magnification, wherein the compound has a specific gravity of at least about 1.5.

2. The compound of claim 1, wherein the carbon nanotubes are single-wall nanotubes.

3. The compound of claim 1, wherein the carbon nanotubes are multi-wall nanotubes.

4. The compound of claim 1, further comprising an optional second polymer selected from the group consisting of liquid crystal polymer, polystyrene, polyimide, polyarylsufone, polyphenylene oxide (polyphenylene ether), polyarylcarbonates, polyamide, fluoropolymer, and combinations thereof.

5. The compound of claim 1, further comprising an optional functional additive selected from the group consisting of adhesion promoters; biocides (antibacterials, fungicides, and mildewcides), anti-fogging agents; anti-static agents; bonding agents; dispersants; fillers and extenders; fire and flame retardants and smoke suppresants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; catalyst deactivators, and combinations of them.

6. The compound of claim 1, wherein the carbon nanotubes have an aspect ratio ranging from 10:1 to 10,000:1.

7. The compound of claim 1, wherein the carbon nanotubes have a diameter ranging from about 0.5 nm to about 1000 nm.

8. The compound of claim 1, wherein the amount of polyphenylene sulfide polymer ranges from about 5 to about 94 weight percent of the compound and wherein the carbon nanotubes range from about 0.1 to about 10 weight percent of the compound.

9. A molded plastic article made from the compound of claim 1.

10. A method of making a compound of claim 1, comprising the steps of
(a) melting polyphenylene sulfide in multiple zones of a twin screw extruder;
(b) at another zone downstream of the multiple zones, mixing into the melted polyphenylene sulfide both glass fibers and carbon nanotubes.
